(19) United States
(12) Patent Application Publication
(10) Pub. No.: US 2001/0034668 A1
(43) Pub. Date: Oct. 25, 2001

(54) Virtual picture hanging via the internet

(76) Inventor: Brian L. Whitworth, Malibu, CA (US)

Correspondence Address: Brian L. Whitworth, 3003 Sequit Dr., Malibu, CA, 90265, US

(21) Appl. No.: 09/770,150

(22) Filed: Jan. 27, 2001

Related U.S. Application Data
(60) Provisional application No. 60/178,863, filed on Jan. 29, 2000.

(51) Int. Cl. G06F 17/60

(52) U.S. Cl. 705/27

(57) ABSTRACT

A method for viewing images of one or more items which a user may be interested in buying and displaying candidate items with one or more images provided by the user, such as a room image, an image of a person, or an image of a car. Methods for replacing, recoloring, or filling all or part of a user's image are provided, such as could be used to simulate the appearance of installed paint, carpet, or wallpaper. Methods are also disclosed where at least one image is animated, moves, morphs, grows, or otherwise changes. Lighting conditions, size, scale, and perspective of one or more images can be adjusted.

### BACKGROUND OF THE INVENTION

1. Field of the Invention

The present invention relates to a system and method for viewing one or more images of items which the viewer may be interested in buying and displaying such images with an image of where it might be placed or mounted. For example, artwork may be displayed with an image of a user's room. Methods are included for: simulating the look of paint or carpet using a current image of a room; trying on virtual clothing or hairstyles using an image of the wearer; for combining images from the user and the website to create intermediate images; and for animated images which simulate movement or changes over time.

2. Description of the Related Art

A shopping trip via the web currently takes a user through what has become the world's largest shopping mall, complete with cars, clothes, artwork, paint, drapes, and even live animals. A great many sites display two-dimensional images of the items for sale. A few even display three-dimensional images, such as cars at Toyota.com, where a 3D rendering can be rotated to any viewing position. However, even the Toyota.com site will not show what the vehicle would look like in your driveway, or what it would look like with you driving the car. Thus, potential buyers using the web cannot currently see how artwork might look in their own living room, how a hairstyle might look on their own head, or how new paint might look on the walls of their own house.

Another problem which often occurs is that an item looks very different in the home or on the wearer than it appeared on the website. A common example would be finding that a particular paint looks vastly different than expected on the walls of your home than on the website, due to lighting of the room or colors of walls, drapes, carpet and furniture.

Methods of Displaying Images of Items for Sale

1. Hangable Artwork, Draperies.

These items are easily displayed as two-dimensional digitized images. Except for black and white artwork, the images are usually in color. The images may be displayed one at a time or many on one page in “galleries”. A typical example of gallery display is used by eBay.com, where a dozen or more images are displayed on a single page, with some description of each artwork, against a white background.

2. Sculpture, Furniture.

Unlike artwork and draperies, for a complete impression of the look of sculpture it is usually necessary to show more than one view or image.

3. Clothing and Hairstyles.

These may be displayed on mannequins, models, average people, or in isolation. Clothing and hairstyles are not currently displayed on images of the potential buyers on the web.

4. Paint, Carpet, Wallpaper.

These are usually displayed as color chips, samples, or swatches. Occasionally, paint, carpet, or wallpaper will be displayed in model rooms, but not the rooms of the actual buyers. Dulux's www.dulux.com is one such site, sponsored by a manufacturer of paints and stains.

5. Automobile Customization.

Custom wheels, paints, body molding and other custom parts are currently displayed either in isolation, or on a model car, but not on an image of the potential buyer's actual car.

Skilled computer users with photo retouching or drawing software can sometimes download or copy images from the web and digitally overlay them on images of their room, car, face, etc. However, this method is not well-adapted to looking at large numbers of potential purchases. For example, if a user wanted to see what 200 different artworks would look like overlaid on an image of their living room, it would be necessary to copy 200 the images from the web. This would take time and disk storage space on the user's computer. In addition, when the images are copied, certain functionality is usually lost. For example, in some galleries clicking on an image will produce a description of the image or allow the user to purchase the image. A copy of just the image taken into a photo-retouching program will not work in this way; it is simply a picture at that point, not a hyperlink.

Viewing Problems.

The lighting conditions used to photograph the items for sale can have an effect on the color of the images. Sites which offer items for sale by third parties will typically receive images photographed under a variety of photographic and lighting conditions which affect the apparent colors of the image. For example, incandescent lighting will impart more red than daylight, while fluorescent will impart more blue. If the item for sale is photographed under different light than where the item will be used or displayed, the buyer may be in for a surprise. This problem is particularly irritating for paint, carpet, and wallpaper, since they are not easily removed or returned after installation.

The color of surrounding items can strongly affect the perceived colors of the item being purchased. Because the seller does not know the current color schemes of potential purchasers' rooms, cars, or faces, this problem exists even when the seller carefully photographs items under controlled conditions. Dulux, the paint manufacturer, has a website which can be used to demonstrate this at www.dulux.com. This website was meant for a different purpose, to demonstrate the look of various paint colors in a model home. However, using the “colour schemer” to vary the colors of paint on the walls also shows how exactly the same artwork and furniture appear very different when the colors of walls and other objects in the model home are changed.

Size can also be a problem, especially on the internet where images usually do not include other items which help give a perception of relative size. Though many sites will give dimensions for such items as artwork or furniture, the buyer may very well open the box for a recently purchased item and say, “It looked a lot bigger on my computer monitor”.

Another problem is that one person may like an item they are about to buy, but their spouse, friends, or children will have quite a different impression. For example, if a person allows someone else to buy artwork for their living room, the person who doesn't buy the art may encounter what is referred to as the “blind date problem”.

Allowing someone else to select artwork can be considerably worse than allowing them to select a blind date. The artwork may cost considerably more than a bad night on the town and, unlike a bad blind date, the undesirable artwork may not leave their house for years. The artwork may hang over the fireplace for a decade or more, mocking the poor soul who allowed their friend or spouse to choose something so inappropriate and so far from their own tastes.

Purchasing via the web may partially alleviate this problem. When shopping at art galleries in the real world, it would be necessary to bring the artwork or a photo of the artwork to the purchaser, or bring the purchaser to the candidate artwork. On the web, it is possible to simply have the potential purchaser look at the image on a computer monitor (after someone else has done the hard work of narrowing the candidates). Unfortunately, even with artwork purchased on the web, it is still difficult to visualize what it will look like in a particular room. Whether an image is displayed on a monitor or printed on a color printer, making color and size matches using current methods involves considerable skill and luck on the part of the user.

Accordingly, none of the prior art satisfies the objectives of the present invention, and none shows the basic features of the invention as described herein. More background information can be found in the following references, the contents of which are incorporated by reference.

Accordingly, it is an object of the present invention to provide a method for displaying an item which may be purchased via the internet by combining such an image with an image of the place where it will be used by the purchaser.

It is another object of the present invention to provide a method for viewing an image of artwork which the viewer may be interested in buying and superimposing such an image on an image of a room where it might be placed or mounted.

It is another object of the present invention to provide a method for simulating the look of paint or carpet using a current image of a room where it might be used.

It is another object of the present invention to provide a method for simulating the look of actual clothing or hairstyles when worn by a particular individual by using an image of the clothing, or hairstyle and one or more images of the individual.

It is another object of the present invention to provide a method for simulating the look of actual automobile customization using an image of a modification or accessory and a current image of the potential buyer's own car.

It is another object of the present invention to provide a method for color correction which makes images of items which may be purchased more representative of their appearance in a particular setting.

### RELATED PROVISIONAL APPLICATION

The applicant claims priority from Provisional Patent Application No. 60/178,863 dated Jan. 29, 2000. Said PPA contains color versions of FIGS. 11-14 of this application and color prior art from: www.victoriassecret.com, www.hairdos.com, www.tswnet.com, www.americanhomedecorating.com, and www.dulux.com.

### SUMMARY OF THE INVENTION

In accordance with an exemplary preferred embodiment of the present invention, virtual picture hanging, a method adapted to: display an image of one or more pieces of artwork which the viewer may be interested in buying and displaying such an image with an image of a room where it might be placed or mounted.

It is further shown how the same approach can be used for other applications, such as virtual paint matching and virtual dress up dolls.

In another aspect of the current invention, the same methods can be employed for virtual furniture arrangement by simply substituting images of furniture for images of artwork.

In another aspect of the current invention, the same methods can be employed for virtual window treatments by simply substituting images of drapes or blinds for images of artwork.

In another aspect of the current invention, similar methods can be employed for virtual paint samples or carpet samples.

In another aspect of the current invention, the same methods can be employed for virtual dress up dolls, by substituting images of the potential clothing purchasers for images of rooms where artwork will be hung and by substituting images of clothing for images of artwork.

In another aspect of the current invention, methods similar to those used in virtual picture hanging can be adapted for automotive accessories.

In another aspect of the current invention, methods similar to those used in virtual picture hanging can be adapted for displaying items which change over time, such as landscaping, with an image supplied by the user.

In another aspect of the current invention, methods similar to those used in virtual picture hanging can be adapted for “morphing” between an image supplied by the user and an image supplied by the website.

### DESCRIPTION OF THE DRAWINGS

Other objects, features and advantages of the invention will become readily apparent upon reference to the following detailed description when considered in conjunction with the accompanying drawings, in which like reference numerals designate like parts throughout the FIGs. thereof, and wherein:

FIG. 1 is a high level, functional flowchart of an exemplary preferred system according to the present invention.

FIG. 2 is a flowchart showing methods of getting digital images of artwork to the website, correcting color and size, and attaching relevant data regarding images.

FIG. 3 is a flowchart showing methods of getting digital images of a room where artwork might be placed into the website.

FIG. 4 is a flowchart showing a method for displaying one or more images of artwork with a room image.

FIG. 5 is a flowchart showing a method for deciding whether to purchase artwork displayed with a room image.

FIG. 6 is a flowchart showing the use of color and/or pattern replacement for simulating paint, carpet, tile, flooring, wallpaper and flooring.

FIG. 7 is a flowchart showing a method for deciding whether to purchase paint, carpet, tile, wallpaper and flooring.

FIG. 8 is a flowchart showing methods of printing or emailing one or more images of candidate artwork with an image of a room where it might be placed.

FIG. 9 is a chart showing required image inputs and sources for applications where one image is overlaid on another image.

FIG. 10 is a chart showing which portions of a buyer's image are modified, and in what manner, to simulate carpet, paint, wallpaper and other items which replace part of the current buyer's room image.

FIG. 11 is a sample screen image for displaying a single artwork overlaid on a background of a room image.

FIG. 12 is a sample screen image for displaying multiple images of artwork overlaid on a background of a room image.

FIG. 13 is a sample screen image for displaying a single artwork in a frame next to a room image.

FIG. 14 is a sample screen image for displaying multiple images of artwork in frames next to a room image.

### DETAILED DESCRIPTION OF THE PREFERRED EMBODIMENTS

The exemplary preferred embodiment, virtual picture hanging, is adapted to: display one or more images of paintings or other artwork and an image of a room where a particular purchaser might hang said paintings or artwork; make color corrections which provide a more accurate portrayal of how a particular artwork would look in a particular setting; allow the user to sort through a number of possible pieces of artwork to display; and provide methods for printing or emailing displays of how artwork would look in a particular settings.

Major Inputs and Outputs

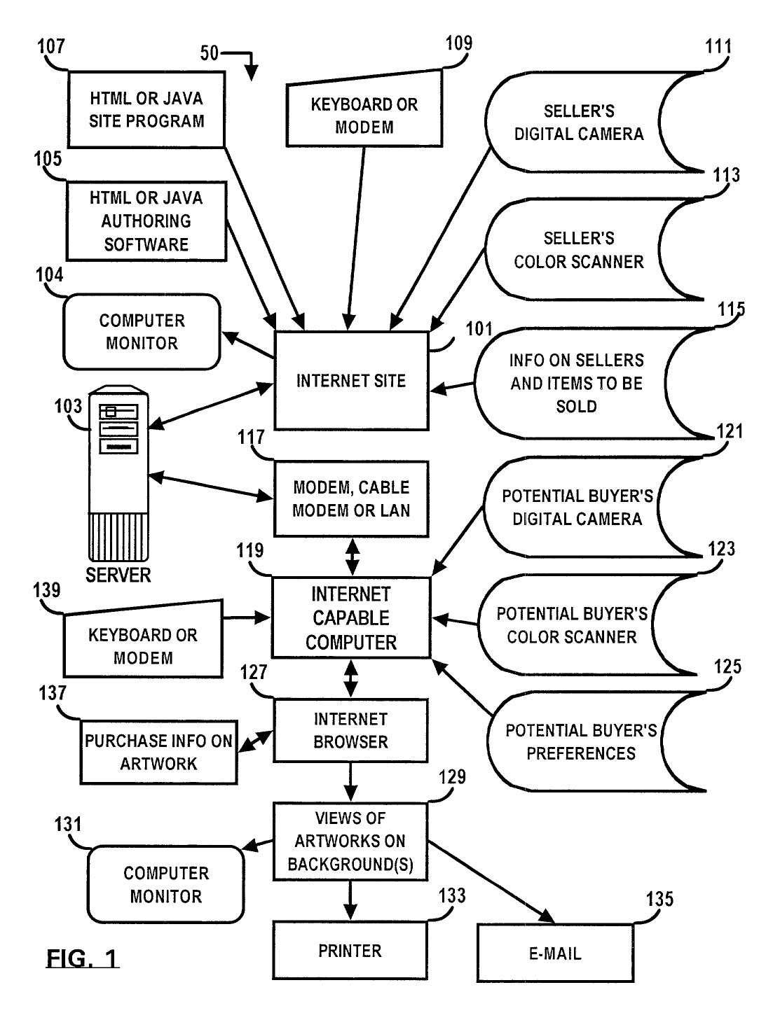

Referring to FIG. 1, a system 50, according to the present invention includes an internet site 101. The internet website 101 is programmed or modified via a keyboard or modem 109, data is stored on a server or other data storage device, such as a hard drive, DVD drive, or floppy disk 103, and can be viewed via a monitor 104. The internet site 101 is programmed using an internet-compatible authoring software, such as html or Java, 105. The program for a specific internet site is in an html or Java program 107. Images of items for sale are input via the seller's digital camera 111, or the seller's color scanner 113. For each item, it is often necessary to input other data on the sellers or the items to be sold such as size, name of artwork, current owner, lighting conditions under which the picture was taken, or asking price 115.

Information for the internet site 101 stored on the server 103 is accessed by users via a modem, cable modem, or local area network (LAN) 117 and an internet capable computer 119. Software running on the internet capable computer 119 includes an internet browser 127, such as Netscape Communicator or Microsoft Internet Explorer. Images of the internet user's home, apartment, office, body, car, or other place where they might use an piece of artwork is input using the potential buyer's digital camera 121 or the potential buyer's color scanner 123. If the potential buyer does not have a digital camera or scanner, images might also be input indirectly using someone else's digital camera or scanner and sending the digital image to the potential buyer using a modem 139. The digital camera 121 does not need to be a still frame camera; a video camera can also provide the necessary images. A keyboard or modem 139, is also used to input other information on a potential buyer's preferences 125. Such preferences might include size of art, desired price range, lighting in which artwork would be displayed, or shipping time.

Images of artworks and one or more images of places where a purchaser might put the artwork are combined to create views of artwork on background(s) 129. Such views are displayed on a computer monitor 131 and may be printed using a printer 133, or sent to someone else via email 135. If the user decides to purchase a particular artwork, required purchase information for artwork 137 is exchanged.

Other methods of inputting programming data may be substituted for the keyboard or modem 109, such as internet downloads, or reading from a floppy or DVD disk. Other methods of storing data may be substituted for the data storage device 103, such as a compact disk or magnetic tape. Other methods for outputting data may be substituted for the printer 121, such as a monitor, projector, plotter, or internet upload. Other methods of inputting images may be substituted for digital cameras 111 and 121 or scanners 113 and 123.

The system 50 is further adapted to print, display, or save, as desired, a virtual picture hanging.

Putting Digital Images of Artwork on the Website

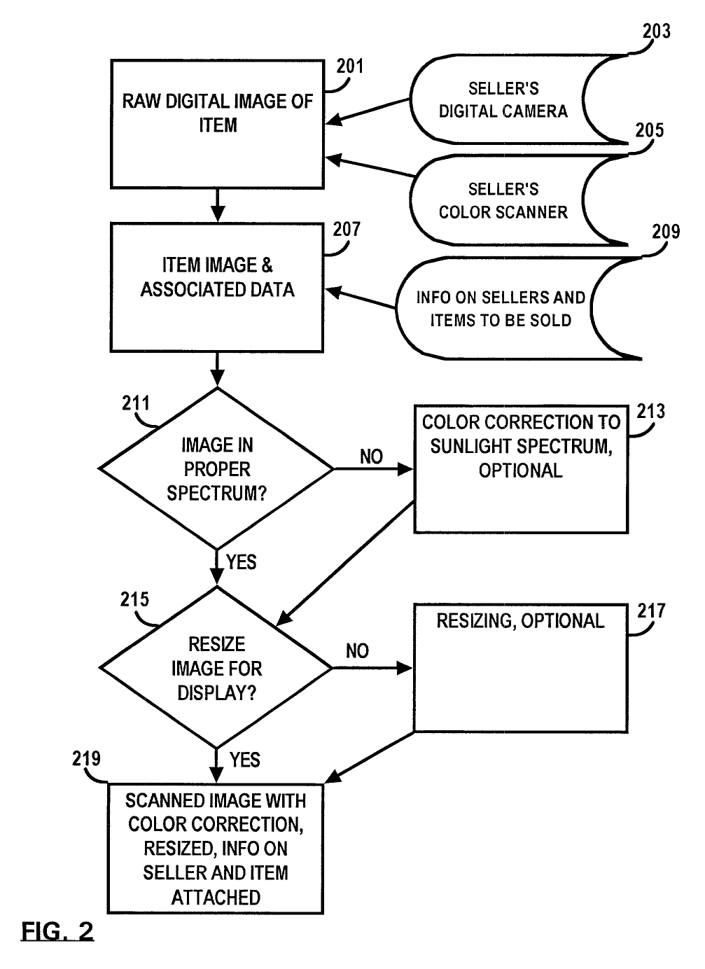

FIG. 2 shows the major steps in getting digital images of artwork onto a website.

A raw digital image of item 201 is typically obtained using a seller's digital camera 203, or a seller's color scanner 205. This raw digital image 201 and information on sellers and items to be sold 209 are combined to create an image of the item with associated data 207. Such data might include size, name of artwork, current owner, lighting conditions under which the picture was taken, or asking price.

Because of difficulties in matching colors caused by photography under different lighting conditions, there is an optional step to see if the image is in the right spectrum 211. Excessive red can be adjusted for using a color correction to sunlight spectrum 213. Fluorescent, incandescent, halogen, and other artificial light sources affect the apparent colors of the artwork in different way when compared to sunlight. For example, if the photo of the artwork was taken under incandescent lighting, the artwork will appear to have more red and less blue than midday sunlight. While digital images can theoretically be digitally converted from their appearance under one light source directly to their appearance under another light source, it is simplest to bring all artwork to the spectrum of sunlight. Sunlight's exact spectral values are very well-known and well-documented. Additionally, if sunlight spectrum is the standard, all artists and owners theoretically have free access to using the standard light source to photograph their artwork. An assortment of color correction methods currently exist. Examples of such methods are the Correct Tint function in Microsoft Picture It! 2.0 software and the Hue Shift function in Paint Shop Pro 6.0 from Jasc Software. After any color correction to sunlight spectrum 213, proceed to resize the image for display 215.

If photos are taken under sunlight, or light sources very close to sunlight, the image is already in the proper spectrum. In that case, proceed to the next optional step, resizing the digital image for display on the website 215. The website can also decide to display images without size modifications and skip steps 215 and 217 for all images, proceeding directly to 219.

There are two likely reasons for resizing. The first reason is that the website may wish to create “thumbnails” of many images in a consistent size, regardless of the size of the original artwork. Thumbnail programs are common for display of many small images on a single page of internet content. The user will usually be able to click on a thumbnail and see a larger, more detailed image.

The second reason is not common in current internet practice, but is particularly useful for this embodiment. Digital images will come to the website in different resolutions and photos will be taken from different distances. The width of one pixel on a particular digital image may correspond to a centimeter on a particular artwork. One pixel on another digital image may correspond to half a centimeter, or two centimeters, on the real artwork. The website may wish to have images set to a particular scale, such as one pixel on the digital image corresponds to one centimeter on the real artwork. While calibrating sizes in this fashion is not common for internet display, it is easily done with inexpensive image manipulation software. One example of a program which can conveniently resize images using several different methods is Paint Shop Pro 6.0 from Jasc Software. If no resizing is required or desired, proceed to 219. If the artist or owner indicates the exact size of the artwork in step 209, this information can be used to resize the image for display 217. After any resizing in 217, proceed to 219.

The website now has a scanned image with color correction which has been resized and contains information on the artist and/or seller 219. This is the image which will be viewed by potential buyers visiting the website.

Preparing Digital Images of a Room Where Artwork Might be Placed

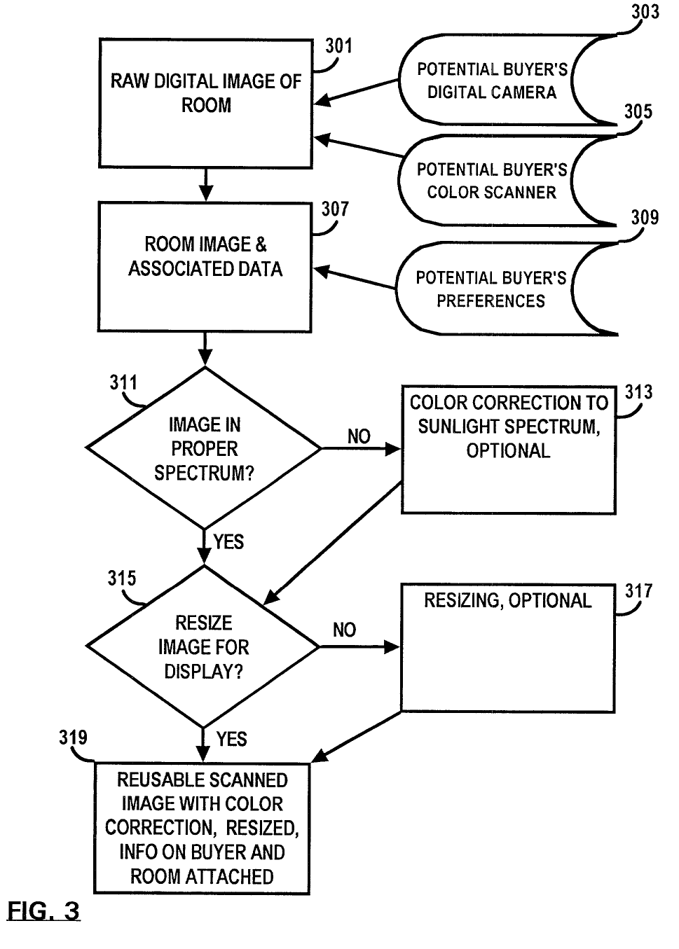

FIG. 3 shows the major steps in getting digital images of a room where artwork might be placed prepared for use on the website. FIG. 3 is similar to FIG. 2 for images of artwork, except for steps 309 vs 209 and 311 vs 211.

A raw digital image of item 301 is typically obtained using a potential buyer's digital camera 303, or a potential buyer's color scanner 305. This raw digital image of the room where artwork might be placed 301 and information on the potential buyer's preferences 309 are combined to create an image of the room with associated data 307. Such data might include preferred sizes, artists, colors, media, or asking price, as well information on what lighting conditions the room image was photographed under.

Because of difficulties in matching colors caused by photography under different lighting conditions, there is an optional step to adjust the room photography spectrum. There may be very good reasons to avoid adjusting the color spectrum of the room photo in 311. The primary reason why a buyer might avoid correcting the color spectrum to sunlight is that the picture was taken under typical artificial lighting conditions for that room. Thus, the buyer has some justification in deciding what the artwork will look like against an image where the room is lighted under its typical artificial lighting conditions. The webmaster might also wish to avoid adjusting the color spectrum of the room photo to reduce internet and server traffic, since room images are typically large files. An interesting alternative is leaving the room spectrum intact in the uploaded file and adjusting the buyer's monitor brightness and colors until it matches the room. This gives a good impression of the final colors.

If desired, there is a color correction to sunlight spectrum 313. If there is no correction to sunlight spectrum for the room image, the artwork spectrum can be adjusted from sunlight to incandescent, fluorescent, or whatever lighting the room photo was taken in. After any color correction to sunlight spectrum 313, proceed to resize the image for display 315.

In order to display artwork images against the background of a particular room, the room image must be somewhat larger than artwork images. Thus, even if it is not being set to a particular scale, the room image would need to be resized so that it is no smaller than the artwork image.

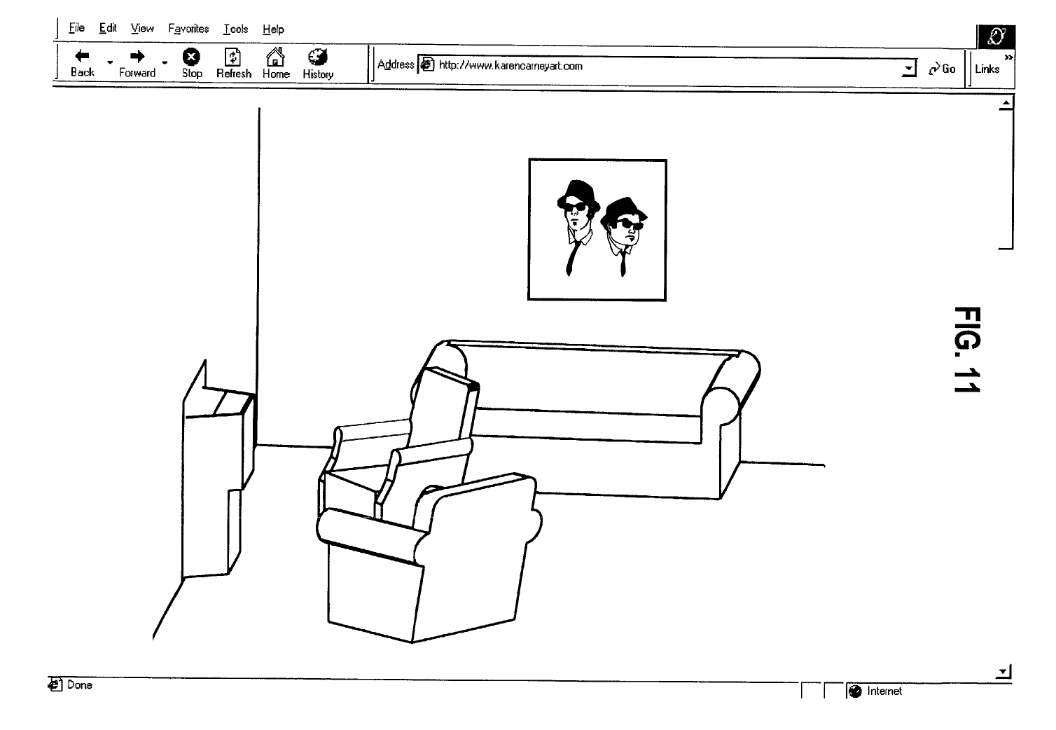

There is an alternative to displaying artwork images against a background image of a room. The images can be displayed side-by-side in separate frames. In this case, each image only needs to fit in the display frame, and would not need to be set to scale. When images are displayed side-by-side in similar frames, color matching can be efficient and website programming is easier than setting images to scale and overlaying one on the other. However, side-by-side display is not as useful for deciding whether artwork is an appropriate size for a particular room. Sample of various methods of displaying artwork images with room images are detailed in FIGS. 11-14.

Just as with artwork images, room images will come to the website in different resolutions and photos will be taken from different distances. If the website has set the size of artwork images to scale, the room images would also likely be set to the same scale, e.g., one pixel=one centimeter. If the buyer has provided size of room information in 309, this can be used to resize the room image for display 317. After any resizing in 317, proceed to 319.

The website now has a scanned room image with any desired color correction and resizing which contains information on the potential buyer's preferences 319. This is the image which will be viewed by a potential buyer visiting the website. This image can also be reused, either at the same site at a later time or on another similar site.

Having a reusable image reduces the amount of work the user will need to do for later shopping on the internet. For example, a woman who regularly buys clothes at www.VictoriasSecret.com could keep one or more useful images, such as an image from 319, either on her own computer or at the website. Someone furnishing a new home might be able to reuse the same room image at many websites. There may even be a use for standard buyer image specifications. Such specifications might detail standards for light level, spectrum, and size of an image to be used by multiple websites. Such standards might specify how some or all of the steps in FIG. 3 would be performed. These standards might be embodied in a Java or HTML plug-in or helper application, which assists potential buyers or users in creating images which are more useful for internet shopping, or creating such images more easily. Such standards might also be created by a body such as World Wide Web Consortium, which defines the standards for HTML, or the Internet Engineering Task Force, which defines a much broader array of internet standards.

Displaying Images of Artwork With Images of a Room, Deciding Which Images to Display

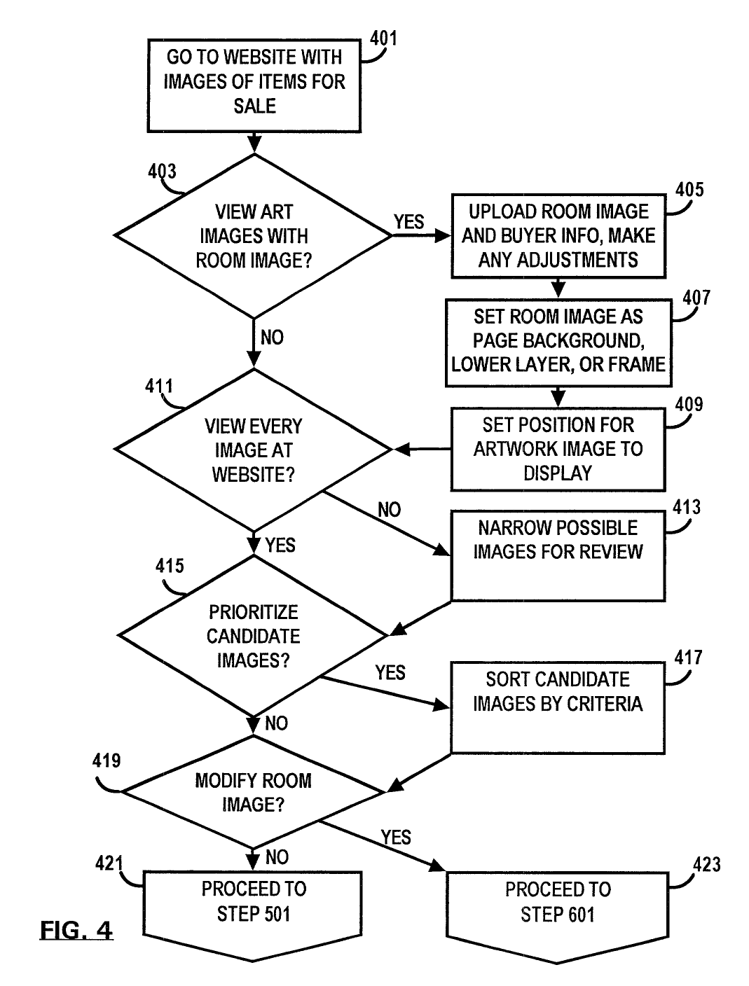

FIG. 4 shows the major steps which a potential buyer will take at a website in order to display images of artwork.

In order to view artwork, the buyer begins by going to a website with images of items for sale 401. It is likely that many sites using the methods for virtual picture hanging described in this embodiment will also allow buyers to browse without using an image of the room where artwork might be placed. Therefore, the website will allow a buyer to choose whether he wishes to view art with a room image 403. If the buyer answers “no”, proceed to 411. If the buyer answers “yes”, an image of a room where a candidate artwork might be hung is uploaded and processed in 405. The steps for preparing the room image in 405 are contained in FIG. 3.

Setting the room image as a page background, a lower layer, or a frame 407, can be done in many ways. A webmaster or website owner will have many choices regarding how to display images of artworks with an image of a room where such artwork might be placed. One choice, shown in FIG. 11, displays a single artwork overlaid on a background of a room image. This is a close simulation of actual size, position, and apparent colors of the artwork. This approach is likely to function best when there are a small number of candidate artworks. There are several ways to program a website so that artworks display in this manner. One method sets the room image as the webpage background. Another uses Netscape's HTML 4.0 <layer> command. Using the <layer> command provides the greatest flexibility, as it allows the room image to be scaled or sized conveniently and allows multiple layers of display. Multiple layers can prove useful if a buyer is considering multiple room modifications, such as buying wallpaper and artwork, for example.

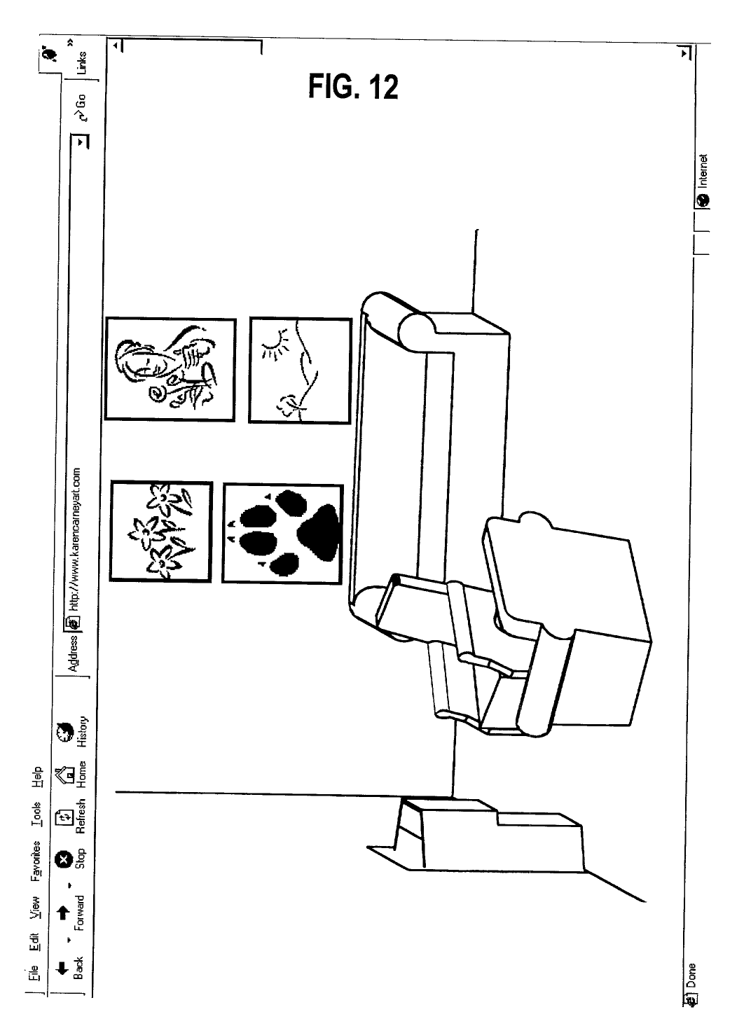

FIG. 12 shows multiple images of artwork overlaid on a background of a room image. The images of artwork might be thumbnails. Many websites currently use multiple thumbnails on a single page to reduce the amount of data transferred when compared to sending full-size images of each artwork. Current websites do not display these thumbnails against a background of the buyer's room. Current websites typically display the thumbnails against solid white background, giving a color impression consistent with a blank, bright white wall illuminated by the midday sun. This can be programmed in a manner similar to FIG. 11.

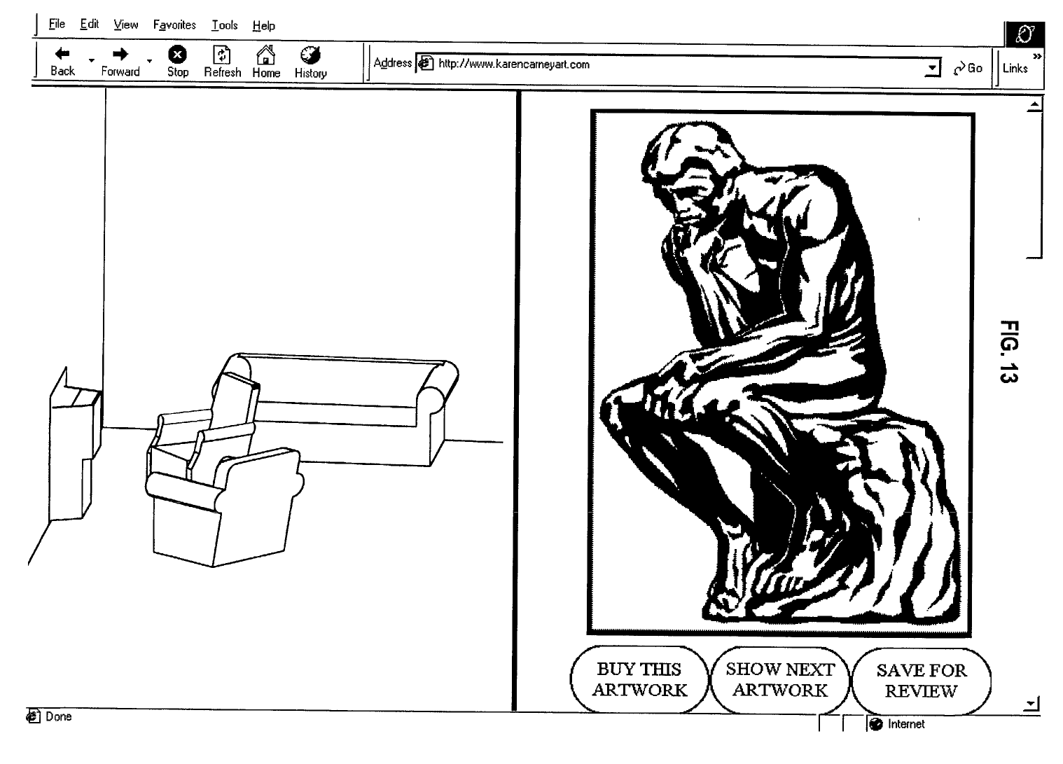

FIG. 13 is a sample screen image for displaying a single artwork in a frame next to a room image. If both the artwork and the room image occupy full frames, the buyer can see great detail in the artwork. Color is emphasized in this method. Of course, as the room is normally much larger than the artwork, there is not a direct size comparison. If desired, the webmaster could have an option for changing from this frame display to the method shown in FIG. 11. Methods for displaying information side-by-side in frames is currently well known to skilled HTML and Java programmers. A display can be split into two or more frames using the <frameset> and <frames> commands in HTML 4.0, for example.

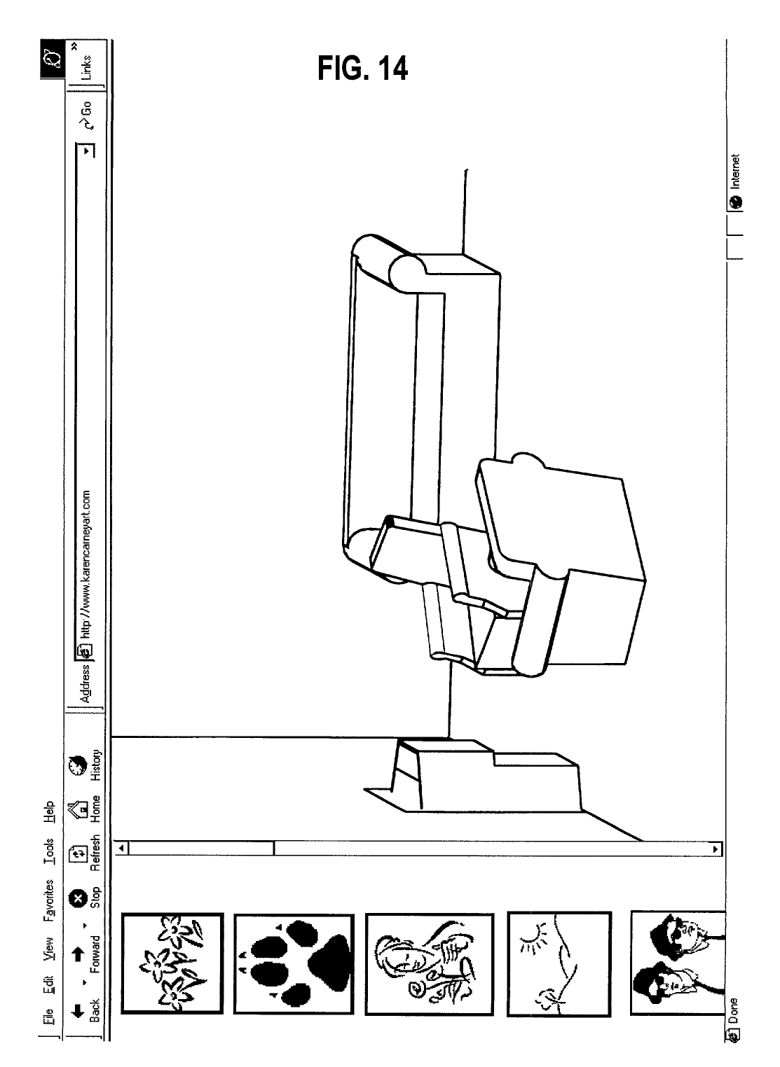

FIG. 14 is a sample screen image for displaying multiple images of artwork in frames next to a room image. Putting the room image in the center aids color comparisons. This display provides advantages of fast file transfer similar to the arrangement in FIG. 12. The display in FIG. 14 is also well-suited to making certain frames containing artwork change while others remain the same. This is useful if a buyer has several preferred artworks which he would like to be able to see at the same time as artworks which he has not yet viewed.

For those display methods where the artwork needs to be positioned on the room image, such as FIG. 12, the next step is to set a position for the artwork image to be overlaid on the room image. For many display methods this step is not needed.

The potential buyer is asked if he would like to view every artwork image on the website 411. At many websites, there will be hundreds or thousands of images. If the buyer answers “yes”, proceed to 415. If the buyer answers “no”, the buyer is able to narrow possible images for review in 413. There are some current methods for selecting artwork, such as artist, price, media, or genre.

New methods of selecting artwork become possible with an image of the room where it might be hung. Some of these methods include: whether a candidate artwork includes colors from the room's palette, whether a candidate artwork contains colors which a color theory predicts will look good with the room palette, and whether the artwork contains colors which an interior design theory predicts will look good with the room palette. Numerous artists and designers are familiar with the intricacies of various theories of color. Most color matching theories can be represented by mathematical operations on a color palette. For example, one color matching theory is complementarity. It suggests that colors will look best together if light in the same palette would add to make white or grey. Using the red, green, and blue values of the room image, a programmer could make a selection tool which chooses artworks with complementary red, green and blue values to the room.

The buyer might also want to prioritize candidate images 415. This choice can easily be omitted by the webmaster. However, as an individual site offers more and more works of art, priortization becomes more desirable. For a site with a small number of offerings, omitting this step may be appropriate. If the buyer answers “no”, proceed to 419. If the buyer answers “yes”, he will be allowed to prioritize images so that artwork more likely to be appropriate is shown first. Some of the methods of prioritization might include size, price, or color palette.

From 419, if the room image itself will be modified, proceed to 601. If artwork will be displayed as an overlay on the room image, proceed to 501.

Deciding Whether to Purchase Artwork

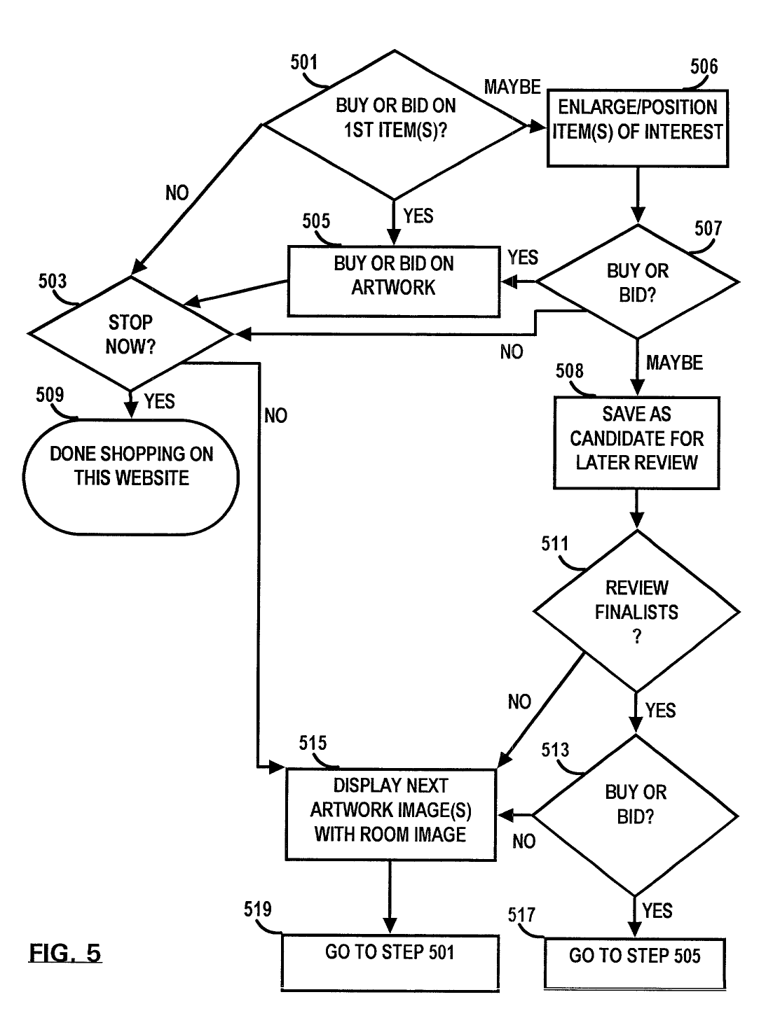

FIG. 5 shows the major steps which a potential buyer will take at a website in order to decide whether to purchase artwork, whether or not images of the artwork are displayed one at a time.

When the first image of an artwork appears on the screen, the potential buyer decides whether they would like to buy or bid on that item 501. If the answer is “no”, proceed to 503. If “yes”, proceed to 505. If “maybe”, proceed to 506.

At 505 the user proceeds through purchase or bidding procedures for the artwork he would like to obtain. There are a variety of commonly used methods for handling such sales or bids, known to many webmasters whose sites offer items for sale or bid. After the sale or bid for the first artwork is complete, proceed to 503.

At 503 the user is asked if they would like to stop shopping now. If “yes”, proceed to 509, the user is done with shopping at this website. If “no”, display the next artwork with the room image 515.

A user who is unsure about purchasing a particular artwork may enlarge or reposition the image(s) of interest 506. The user can then revisit the decision to buy or bid 507. If “yes”, proceed to 505. If “no”, proceed to 503. If still “maybe”, save the artwork as a candidate for later review 508.

If the user is ready to review finalist images 511, a “yes” allows the user to buy or bid on any of the finalists 513. If the user wishes to buy or bid on at least one artwork, a “yes” advances the user to 517, which moves the user to procedures for buying or bidding on artwork 505.

If the user is not ready to review images at 511, a “no” allows the user to display the next artwork image(s) 515. Similarly, if the user decides he is not ready to buy or bid on finalist artwork 513, a “no” advances the user to 515.

After displaying the next artwork 515, 519 directs the process back to 501 where the choices regarding buying or bidding art repeated for the current image.

Preparing Digital Images for Simulation of Paint, Carpet, Wallpaper, Tile or Flooring

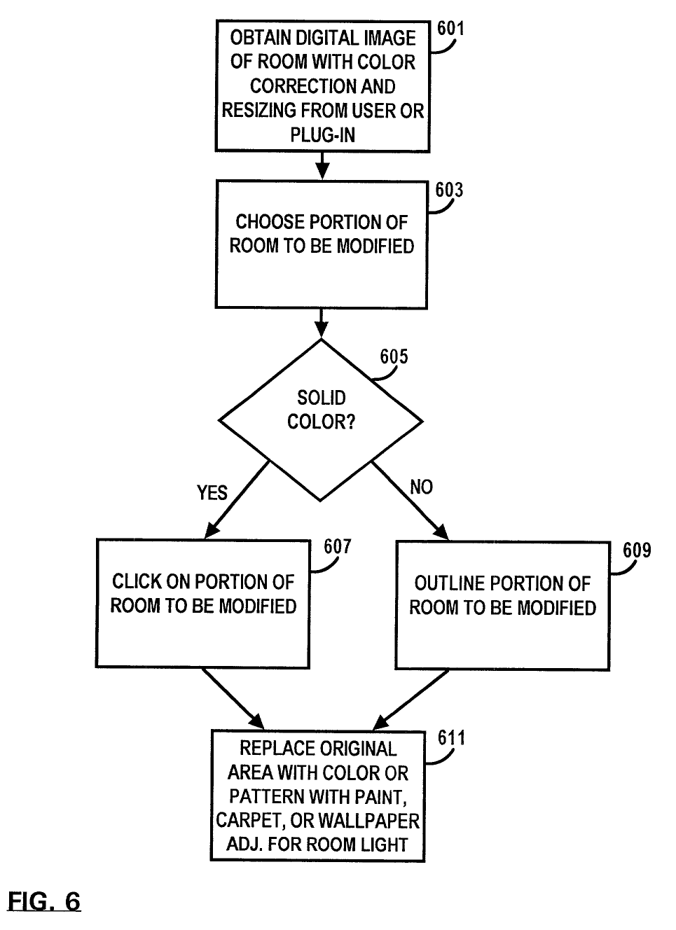

FIG. 6 is a flowchart showing the use of color and/or pattern replacement for simulating paint, carpet, tile, wallpaper and flooring. The techniques required for these applications are slightly different than for virtual picture hanging. In virtual picture hanging, an image of artwork is placed next to or over a room image. For simulation of paint, carpet, wallpaper, tile, or lighting, the buyer's room image itself will be modified.

The process commences with a digital image of a room, which may have had color correction or resizing. Such an image might come from 319 in FIG. 3 or from a Java or HTML program. The buyer chooses the portion of the room to modify 603. For example, if the user will be painting a wall, the user will want to select that wall. If the user would like to buy new carpet, he will select the carpeted area of the floor. The user can leave any artwork hanging on the wall, or furniture on the floor in place for the simulation.

For technical reasons, the user indicates whether the area he would like to modify is a solid, or nearly solid, color versus a pattern 605. If the color is solid, or nearly solid, proceed to 607. Otherwise, a “no” advances to 609.

Many paint and photo-retouching programs can easily deal with color replacement in a solid area. One example is the flood fill tool in Paint Shop Pro 6.0. The user can point anywhere on a solid color area of a photo and have the flood fill tool replace that color with another color or pattern of the user's choosing. The flood fill tool also has an adjustable tolerance for variations in color which will be treated as the same color when performing a flood fill. Thus, texturing and modest differences in lighting are tolerated when using flood fill. Flood fill tools usually leave furniture and wall decorations intact in their original colors, unless their colors are very close to the solid color area being filled. These functions are very useful for replacing painted or carpeted areas with other colors of paint, wallpaper or carpet.

For patterned areas, it is difficult to use a flood fill or similar tool. Thus, patterned wallpaper will likely require the user to outline the portion of the room to be modified by hand 609. This method can also be used if a fill tool is producing undesirable results, such as changing the color of a piece of furniture as well as the carpeting the user wants to replace. Any closed shape or shapes will work when using the outline method. These shapes are represented by coordinates which can be used by an HTML or Java program to represent the area to be replaced. In HTML 4.0, the <area> tag can be used, with the attribute for coordinates set to “polygon” to define the area to be covered or colored.

After the area to be modified has been defined, the user can browse the website for something they might like and then replace the original area with a color or pattern representing paint, carpet, wallpaper or tile 611. The colors of the items to be purchased can be adjusted for room lighting in a manner similar to that for displaying artworks.

Deciding Whether to Purchase Paint, Wallpaper, Carpet, Tile, or Flooring

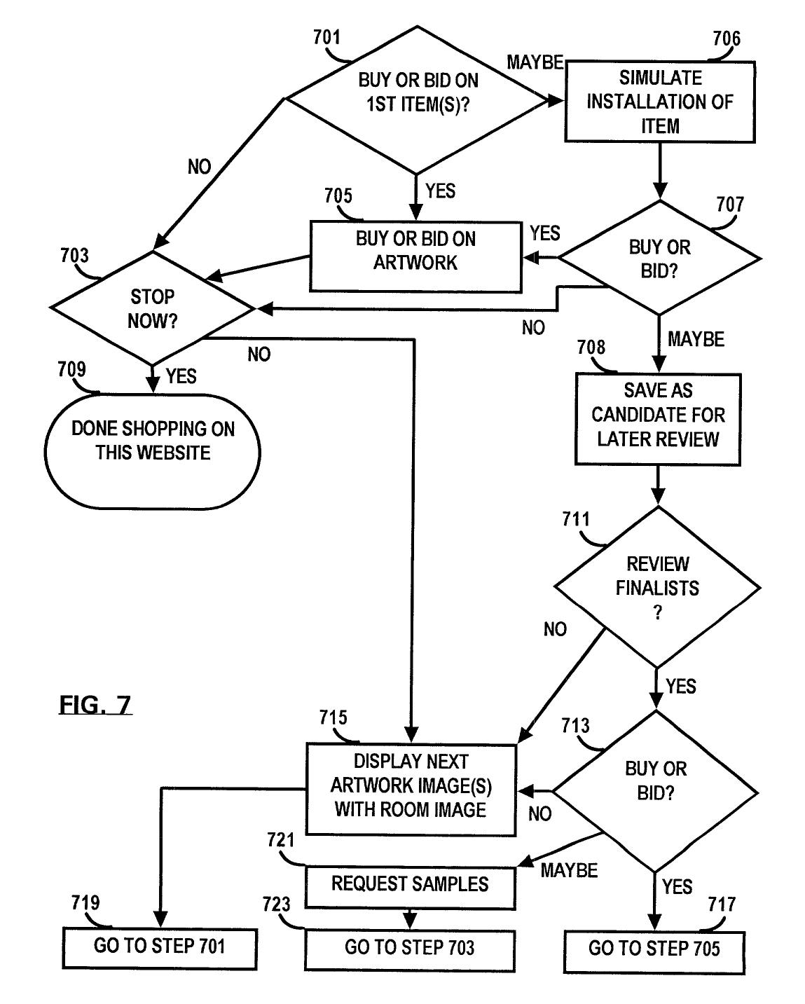

FIG. 7 shows the major steps which a potential buyer will take at a website in order to decide whether to purchase paint, wallpaper, carpet, tile, or flooring. It is similar to FIG. 5 for artwork, except for steps 706, 713, 721 and 723.

When the first image(s) of paint, wallpaper, carpet, tile or flooring appear on the screen, the potential buyer decides whether they would like to buy or bid on any item 701. These images may be displayed overlaid the room image or next to the room image. If the answer is “no”, proceed to 703. If “yes”, proceed to 705. If “maybe”, proceed to 706.

At 705 the user proceeds through purchase or bidding procedures for the paint, wallpaper, carpet, tile or flooring he would like to obtain. There are a variety of commonly used methods for handling such sales or bids, known to many webmasters whose sites offer items for sale or bid. After the sale or bid for the first paint, wallpaper, carpet, tile or flooring is complete, proceed to 703.

At 703 the user is asked if they would like to stop shopping now. If “yes”, proceed to 709, the user is done with shopping at this website. If “no” display the next paint, wallpaper, carpet, tile or flooring with the room image 715.

A user who is unsure about purchasing particular paint, wallpaper, carpet, tile or flooring may simulate installation of the item 706. This can be done by replacing a portion of the room image provided by the buyer with a different color or pattern. Alternatively, the paint, wallpaper, carpet, tile or flooring can be displayed in a second layer above the layer containing the room image. Particularly where changes are only being simulated for a small portion of a room image, this will allow faster redraws, since only the smaller top layer is being redrawn for each potential modification.

The user can then revisit the decision to buy or bid 707. If “yes”, proceed to 705. If “no”, proceed to 703. If still “maybe”, save the paint, wallpaper, carpet, tile or flooring as a candidate for later review 708.

If the user is ready to review finalist images 711, a “yes” allows the user to buy or bid on any of the finalists 713. If the user wishes to buy or bid on at least one paint, wallpaper, carpet, tile or flooring, a “yes” advances the user to 717, which moves the user to procedures for buying or bidding 705.

If the user is not ready to review images at 711, a “no” allows the user to display the next paint, wallpaper, carpet, tile or flooring image(s) 715. Similarly, if the user decides he is not ready to buy or bid on finalists 713, a “no” advances the user to 715. If the user is still undecided about buying or bidding, a “maybe” advances to 721. The undecided user may request samples of the paint, wallpaper, carpet, tile or flooring 721. After requesting samples, 723 directs the process back to 703, where the user decides whether to continue shopping or stop now.

After displaying the next paint, wallpaper, carpet, tile or flooring 715, 719 directs the process back to 701 where the choices regarding buying or bidding repeated for the current image(s).

Printing or Emailing Images of Artwork with an Image of a Room

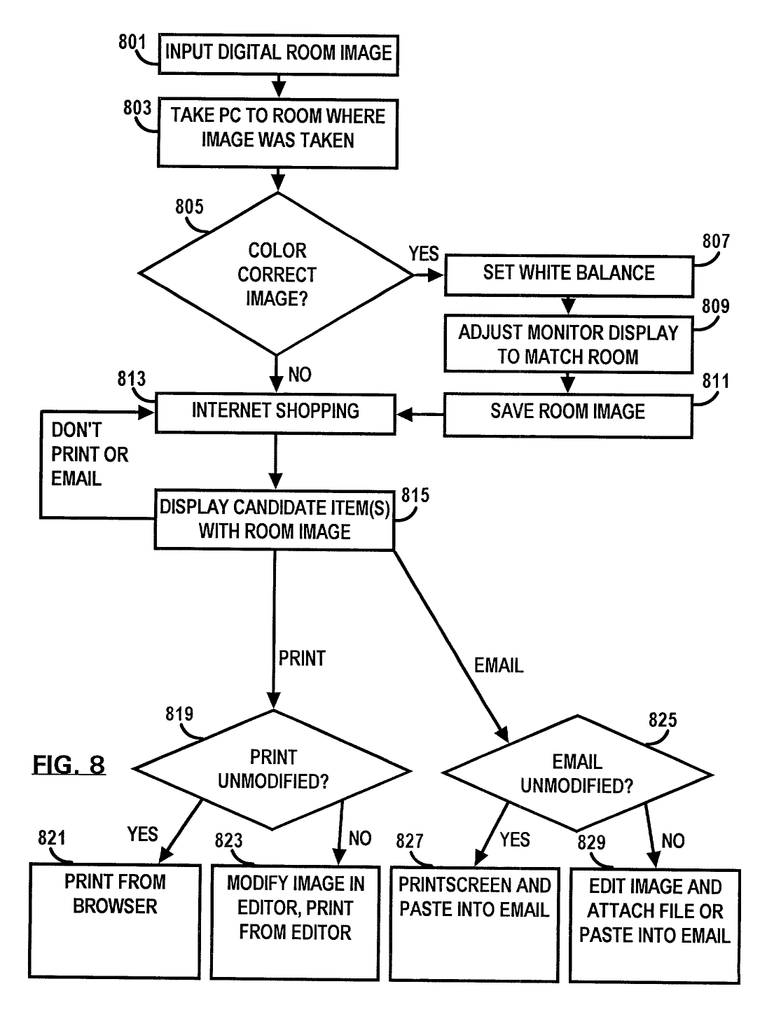

FIG. 8 is a flowchart showing methods of printing or emailing one or more images of candidate artwork with an image of a room where it might be placed and shows optional color correction methods for the images.

A particularly straightforward method of calibration uses the digital room image 801 and a computer which can be taken to the room where the image was photographed 803. The digital image is displayed on a monitor located in the same room where the image was photographed, and when the room is under similar lighting conditions. The user then decides whether to make color corrections on the image 805. If the image on the monitor is already quite close to appearance of the actual room, or the user wants to avoid extra effort and begin internet shopping immediately, “no” advances to 813.

If the user wishes to color correct the image, “yes” advances to 807. If the photo of the room was taken with a very white object in view, such as a white piece of paper, the image can be brought into photo-retouching software which adjusts the colors based on the white area, such as Microsoft Picture It! 2.0. This adjusted color image will be used for comparison when shopping on the internet. Next, the colors on the computer monitor itself, not the image, are adjusted until the image on the monitor looks very similar to the actual room 809. The user then saves the room image 811 and begins internet shopping 813.

When the user finds an image of an item which he might wish to buy, the candidate image is displayed overlaid on or next to the room image 815. If the user would like to print a copy of the item with the room image proceed to 819. If the user would like to email a copy of the item with the room image, proceed to 825. If the user does not wish to print or email, return to 813 and continue shopping.

The user may choose to print the unmodified file 819 or make modifications before printing. If “yes” proceed to 821. If “no”, proceed to 823. The displayed screen can be printed directly from the internet browser without edits 821. To modify the image in a paint, image processing or similar editor and print from that software 823, the user can press the printscreen key while at the desired display and paste that image from the Windows clipboard into the editor. In the editor any extraneous items which were also displayed on the same web page, such as advertisements, can be cropped or removed. All of the usual options available in the editor are now available for the print screen image. The user prints the image when it is modified to his satisfaction.

If the user wishes to email an image of an item with a room image, he may choose to send the email with an unmodified image 825 or with a edit the image before emailing. If “yes” proceed to 827. If “no”, proceed to 829.

The screen image can be emailed unmodified using the printscreen key and many email programs 827. The printscreen key will copy the current display on the monitor to the Windows clipboard. Many email programs will allow a user to paste any image from the clipboard directly into an email. For example, Netscape Communicator 4.7 will allow users to paste printscreen images directly from the Windows clipboard into the body of an email using “edit/paste”.

If the user would like to edit the image before attaching it to an email as a file or pasting it into an email, the user can capture the image by pressing the printscreen key while at the desired display and paste that image from the Windows clipboard into image or photo software. The user can make any desired modifications in the editor. The modified image is saved or copied and then sent as an email attachment or printed. Such emails or printouts will be valuable for showing others how an item will look in the room.

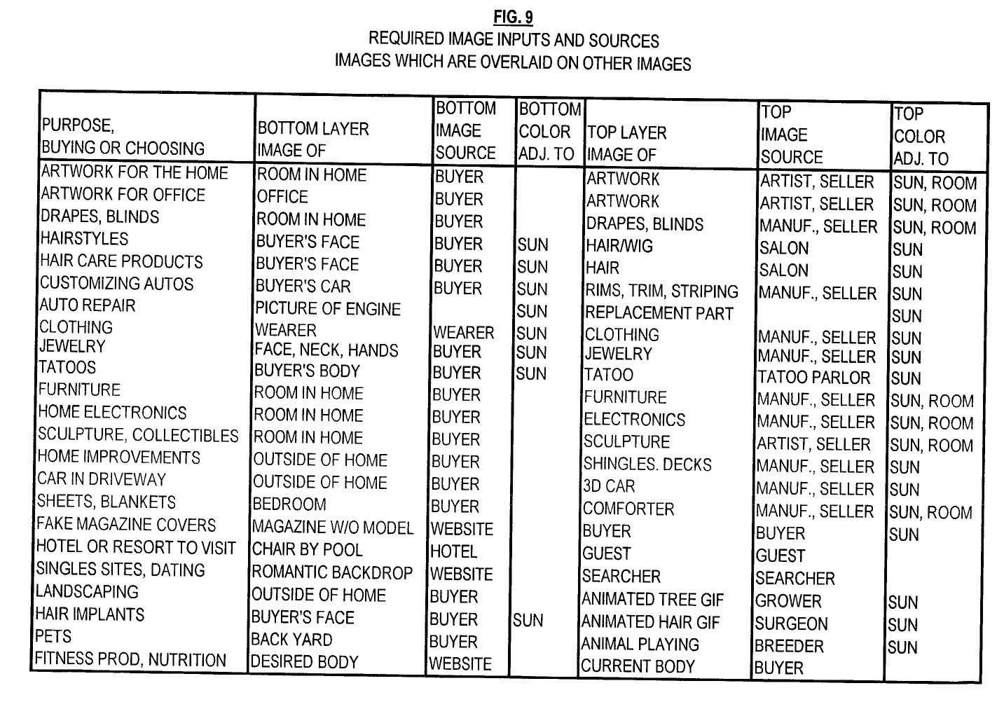

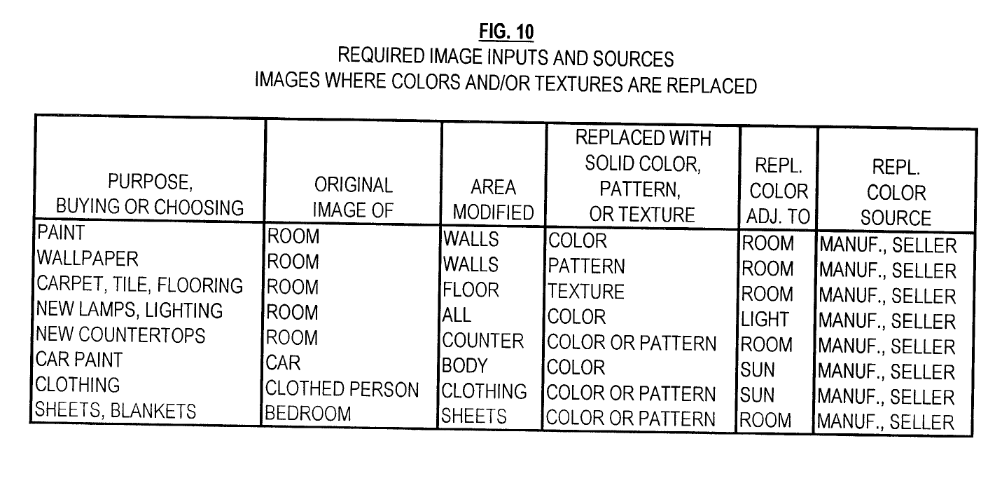

The methods described in FIG. 8 are virtually identical for other items purchased on the internet and FIG. 8 should not be interpreted as restricted to artwork nor room images. FIGS. 9 and 10 show various combinations of images supplied by the user and the website which can work in similar fashions to those described for artwork.

FIG. 9 is a chart showing required image inputs and sources for internet applications where one image is overlaid on another image or combined with another image. The applications are in approximate order of complexity for website programming.

The first group consists of color corrected overlays of one opaque image on a background of another image. The opaque image is usually rectangular or a simple polygon.

The second group typically uses either very irregular shapes for the overlaid image or an overlaid image where a portion is transparent. For example, simulating hairstyles requires a curved transparent space through which an image of the user's face can be seen.

The third group consists of images overlaid on background images, where the top image needs to look representative of its actual appearance on a three-dimensional human. In a simple version of simulating the look of clothing, the wearer's image is used as a background and an item, such as a sweater, is superimposed. This method is similar to the way children's paper dress-up dolls function. For a better simulation of the look of clothing, size and lighting effects need to be taken into account.

The fourth group consists of three-dimensional items which require a perspective match in order to correctly simulate their appearance. The 3D item being used as an overlay should be viewed from an angle similar to that used to take the photo used as a background image. 3D rendering software capable of showing a 3D object from multiple perspectives is occasionally used on current internet sites, such as Toyota.com. However, the additional step of overlaying the 3D image on a background image would make for a better simulation. For example, a 3D rendered image of a new car could be overlaid on an image of the potential buyer's house and driveway to show what the car might look like at its prospective new home.

The fifth group consists of images where the user supplies an overlay image with an irregularly shaped boundary and the seller supplies the background image.

The sixth group consists of overlay images which can be animated. Most animations tend to fall into two groups: changes over time and live action. Showing how trees would look, from the time of planting until maturity, is an example of simulating changes over time. This would allow users to watch for effects such as blocking the view from one or more windows.

An example of overlaying live action would use a picture of a pet at play superimposed on an image of the potential new owner's back yard. While such technology is not currently used on the internet as an overlay to a user-supplied image, the technology for creating this animation is quite familiar to special effects artists who use blue-screen or green-screen techniques for movie and television production. The animal is photographed against a solid color backdrop. The backdrop is then digitally removed, leaving an image consisting only of the animal at play.

The seventh group consists of combining an image from a user with an image at the website to create an intermediate image, rather than an overlay. The technology for combining two images to create a third image which is intermediate between the two is known as “morphing” or “tweening”. This technology is well known to movie and television special effects artists. If this technique is modified to allow a user to submit one at least one photo via the internet, new and interesting creative applications arise. One example of this technology is simulating “during” and “after” pictures for someone who is considering buying exercise equipment. The user could supply a current photo, the “before” photo, and choose a photo of a model who is in better shape from the website. The morphing process could simulate what the user would look like at various points in time as a result of using the exercise equipment.

FIG. 10 is a chart showing which portions of a buyer's image are modified, and in what manner, to simulate carpet, paint, wallpaper, tile and other items which replace part of the current buyer's room image. Note that certain items appear in both FIG. 9 and FIG. 10, such as clothing.

If a person is photographed using clothing of a similar cut to the one being considered for purchase, a flood fill can simulate the look of the latter. Skilled webmasters would even be able to extract the shading and highlighting information, known as “luminance”, from the original photo of the clothed user. It is this shading and highlighting information which helps humans to infer shape from two-dimensional images. One method of creating such color replacements for photos is using the Flood Fill tool in Paint Shop Pro 6.0, with the blend mode set for “luminance”. Astute readers of certain current clothing catalogs will notice various colors or patterns of the same garment modeled in exactly the same position by the same model. This is not an indication of the model's ability to repeat poses; in fact she has probably only worn one color of the garment. The other colors are simulated by computer, usually preserving the luminance from the original photo to simulate the proper shape and lighting on the computer-generated photos.

More than one modification or overlay can be done to the same photo. For example, a flood fill could be used to simulate the look of a sweater on a buyer. Then, an overlay could be used to show how a butterfly pin would look attached to the sweater. As another example, one flood fill could be used to simulate carpeting and another to simulate paint, on the same user's photo. Multiple layers of overlays are also possible, such as overlaying a dining room table on the buyer's image of a dining room, and then overlaying a china set on the dining room table.

FIG. 11 is a sample screen displaying a single artwork overlaid on a background of a room image. This type of display is effective for reviewing one item at a time. This type of display will be more common when there is a small number of candidate items for sale or auction, and where size, placement or perspective are important. Users with more than one candidate item to review may display each item in sequence.

FIG. 12 is a sample screen displaying multiple images of artwork overlaid on a background of a room image. This type of display can accommodate reviewing multiple items at one time. It is effective for reviewing multiple items and can accommodate color correction of multiple items to room lighting conditions simultaneously. It can be used with or without the items set to the scale or perspective of the room.

FIG. 13 is a sample screen displaying a single artwork in a frame next to a room image. This method displays a room image (or any image provided by the user) next an image for sale or auction. In many cases, this will be a very easy type of display to program: it does not require placement or scaling of one image on another.

FIG. 14 is a sample screen displaying multiple images of artwork in frames next to a room image. In this case, the user can scroll through a selection of items. This method can be very effective where there are a large number of candidate items. The user might take a closer look at the best candidate item(s) using another type of display, such as the displays in FIGS. 11-13.

Of course, the same user image(s) or item(s) for sale or auction can be displayed in various other manners. While the sample screen displays in FIGS. 11-14 of this application are in black and white, most implementations will be in color.

Conclusion, Ramifications, Scope

Thus, the reader will see that virtual picture hanging is a method which provides better visualization for a potential buyer, resulting in better choices and fewer returns.

While the description above contains many specificities, these should not be construed as limitations on the scope of the invention, but rather as an exemplification of one preferred embodiment thereof. Many other variations are possible. For example, a local area network may be substituted for the internet. Accordingly, the scope of the invention should be determined not by the embodiment illustrated, but by the appended claims and their legal equivalents.

I claim:

1. A method of displaying at least one image of an item for sale or auction via the internet wherein:
One or more images of items for sale or auction are displayed simultaneously with one or more images provided by a potential buyer.

2. The method of displaying images of claim 1, wherein:
the one or more items for sale or auction are selected from the group consisting of artwork, sculpture and collectibles.

3. The method of displaying images of claim 1, wherein:
the one or more items for sale or auction are selected from the group consisting of drapes, curtains, window shades and blinds.

4. The method of displaying images of claim 1, wherein:
the one or more items for sale or auction are selected from the group consisting of hairstyles and hair care products.

5. The method of displaying images of claim 1, wherein:
the one or more items for sale or auction are selected from the group consisting of plants, landscaping, and exterior home improvements.

6. The method of displaying images of claim 1, wherein:
the one or more items for sale or auction consist of clothing.

7. The method of displaying images of claim 1, wherein:
the one or more items for sale or auction are selected from the group consisting of furniture, fitness equipment and home electronics.

8. The method of displaying images of claim 1, wherein:
the one or more items for sale or auction are selected from the group consisting of new cars and used cars.

9. The method of displaying images of claim 1, wherein:
the one or more items for sale or auction are live animals.

10. The method of displaying images of claim 1, wherein:
the method of displaying images is overlaying images of one item at a time on an image provided by a potential buyer.

11. The method of displaying images of claim 1, wherein:
the method of displaying images is overlaying images of two or more items at a time on an image provided by a potential buyer.

12. The method of displaying images of claim 1, wherein:
the method of displaying images is overlaying one or more images provided by a potential buyer on an image provided by the website.

13. The method of displaying images of claim 1, wherein:
the method of displaying images is displaying images of one item at a time next to an image provided by a potential buyer.

14. The method of displaying images of claim 1, wherein:
the method of displaying images is displaying images of two or more items at a time next to an image provided by a potential buyer.

15. The method of displaying images of claim 1, wherein:
the image submitted by the user is an image of all or part of a person.

16. The method of displaying images of claim 1, wherein:
an image of a model displayed via the internet is combined with an image submitted by a user over the internet, to create at least one image which is a mixture of both images.

17. The method of combining images of claim 16, wherein:
(a) the image of a model is a human model, and
(b) the image submitted by a user is an image of a different human.

18. The method of combining images of claim 16, wherein:
images are combined using morphing technology.

19. The method of combining images of claim 16, wherein:
images are combined to create multiple images with varying degrees of similarity to the image submitted by the user.

20. The method of combining images of claim 1, furthermore comprised of:
printing one or more of said images.

21. The method of displaying images of claim 1, wherein:
the display simulates the appearance of one or more items in consideration of characteristics of images selected from the group consisting of colors and lighting conditions.

22. The method of simulating the appearance of one or more items of claim 21, wherein:
the simulation adjusts for lighting conditions selected from the set of sunlight, incandescent light, fluorescent light, and halogen light.

23. The method of simulating the appearance of one or more items of claim 21, wherein:
the simulation places the image of an item in a position where a buyer might place the item or items.

24. The method of simulating the appearance of one or more items of claim 21, wherein:
the simulation sizes images of one or more items and an image of a place where a buyer might put such items so that the relative sizes of the images approximates their relative sizes in the real world.

25. The method of simulating the appearance of one or more items of claim 21, wherein:
the simulation adjusts images of one or more items and an image of a place where a buyer might put such items to match the relative viewing perspectives.

26. The method of displaying images of claim 1, wherein:
the image of one or more items for sale or auction are overlaid on an image provided by a potential buyer by using the HTML <layer> command.

27. The method of displaying at least one image of an item for sale or auction via the internet of claim 1, wherein:
One or more still images submitted by a user via the internet are displayed with one or more moving or animated images provided at a website.

28. The method of combining a still image with a moving or animated image of claim 27, wherein:
the moving or animated image portrays one or more items selected from the group of plants, landscaping and live animals.

29. The method of combining a still image with a moving or animated image of claim 1, furthermore comprised of:
emailing one or more of said images.

30. The method of displaying images of claim 1, wherein:
one or more images have standard characteristics selected from the group consisting of standard colors displayed within the image, standard lighting conditions, a test pattern display within the image, and a scale of measurement.

31. The method of displaying images of claim 1, wherein:
one or more images provided by a potential buyer can be saved on a website for later reuse.

32. The method for saving files for later reuse of claim 31, wherein:
reusable files from one or more images provided by a potential buyer a modified to fit specifications created by an entity selected from the group consisting of websites, the Internet Engineering Task Force, or the World Wide Web Consortium, such files being created to aid shopping via the internet.

33. A method of simulating the appearance of one or more items for sale or auction wherein:
colors or patterns in one or more images submitted by a user via the internet are replaced with other colors or patterns representing one or more items which the user might purchase.

34. The method of replacing colors or patterns claim 33, wherein:
the item or items which the user might wish to purchase are selected from the group consisting of paint, carpet, tile, flooring, wallpaper, and countertops.

35. The method of replacing colors or patterns of claim 33, wherein:
the one or more images submitted by a user via the internet are images of all or part of a person.

36. The method of replacing colors or patterns of claim 33, wherein:
the one or more items which a user might purchase are clothing.

37. The method of replacing colors or patterns of claim 33, wherein:
the one or more images submitted by a user via the internet are images of one or more automobiles.

38. The method of replacing colors or patterns of claim 33, wherein:
the one or more images submitted by a user via the internet are images of furniture.

39. The method of replacing colors or patterns of claim 33, wherein:
the method of replacing colors or patterns is a flood fill technique.

40. The method of replacing colors or patterns of claim 33, wherein:
the method of replacing colors or patterns is an overlay technique.

41. The method of replacing colors or patterns of claim 33, wherein:
the portion of the one or more images for which colors or patterns will be replaced is defined by a user outlining one or more areas on images submitted by such user.

42. A method of selecting candidate items for possible purchase, wherein:
colors of items for sale or auction and colors of one or more images submitted by a user are compared to select candidate items of interest.

43. The method of selecting candidate items for possible purchase of claim 42, wherein:
the method of selection uses mathematical operations on the colors of the image or images of where the items might be placed to select candidate items.

44. The method of selecting candidate items for possible purchase of claim 42, wherein:
the method of selection uses a color theory for predicting which items will appear most desirable, based on colors of an image where the items might be placed.
